(19) United States
(12) Patent Application Publication
(10) Pub. No.: US 2014/0041991 A1
(43) Pub. Date: Feb. 13, 2014

(54) CHECKING STATION, SEPARATING DEVICE AND METHOD FOR SEPARATING PIECE GOODS

(71) Applicant: SSI Schaefer PEEM GmbH, (US)

(72) Inventor: Max Winkler, Graz (AT)

(73) Assignee: SSI SCHAEFER PEEM GMBH, Graz (AT)

(21) Appl. No.: 13/754,169

(22) Filed: Jan. 30, 2013

Related U.S. Application Data
(63) Continuation of application No. PCT/EP2011/062279, filed on Jul. 18, 2011.

(30) Foreign Application Priority Data
Jul. 30, 2010 (DE) 10 2010 033 697.1

(51) Int. Cl. B65G 47/26

(52) U.S. Cl. CPC B65G 47/268
USPC 198/462.3

(57) ABSTRACT

A separating device for separating a quantity of piece goods, which are provided in a geometrically disordered state and which were collected in accordance with a picking order, into a row so that the piece goods are lined up one behind the other, comprising: a conveyor having a receiving zone and a discharging zone, wherein the conveyor comprises a conveying surface on which the piece goods are transported in a main conveying direction from the receiving zone downstream to the discharging zone, wherein the discharging zone is arranged at a downstream end of the conveyor; and a guiding device, arranged such that the piece goods are conducted in the main conveying direction to the discharging zone; wherein the conveyor comprises a plurality of conveyor segments each having a longitudinal extension, wherein the conveyor segments are arranged side-by-side along the main conveying direction, wherein each of the longitudinal extensions is orientated obliquely relative to the main conveying direction, and wherein each downstream located one of the conveyor segments is operated at a higher velocity than the one of the conveyor segments being located upstream adjacent thereto. (FIG. 1)

### RELATED APPLICATIONS

This is a continuation application of the co-pending International application WO 2012/013532 A1 (PCT/EP2011/062279) filed on Jul. 18, 2011, which claims priority of the German patent application DE 10 2010 033 697.1 filed on Jul. 30, 2010, which is fully incorporated by reference here.

### BACKGROUND OF THE INVENTION

The present invention relates to a checking station, a separating device and a method for separating a quantity of piece goods, which are provided in a geometrically disordered state. The present invention is used in order-picking systems, where different piece goods are collected in accordance with picking orders.

### RELATED PRIOR ART

In the beverage industry sorting devices (e.g. DE 31 28 460 A2), for compacting beverage bottles exist, which are supplied in parallel on multiple tracks, to one single track. The bottles are all of the same size and have identical dimensions. A plurality of plate belts are used, which are arranged parallel next to one another. The plate belts are driven at increasing speeds. The sorted bottles leave the device in one row without a distance between adjacent bottles.

In particular in the field of order-picking a requirement exists for checking piece goods, which were collected in accordance with a picking order, with regard to whether the collected piece goods correspond, in type and number, to the specifications (order lines) of the picking order. In order to avoid picking errors, each of the picking orders, i.e. the quantity of the piece goods collected in accordance with the picking order, should be checked.

One possibility of checking is, for example, to weigh an order container, i.e. a collecting container, before the picking process and after the picking process. If a measured weight matches an expected weight, wherein the weights of the container and the different piece goods are stored in a central computer, the probability is relatively high that the picking order was performed correctly, i.e. all of the desired product types are present in the desired number. This method is, however, not reliable since different product types may have similar weights so that the picking order contains false product types despite a matching weight.

Alternatively, the piece goods can also be controlled manually by taking same in hand and checking each of the piece goods after the completion of a picking process.

Further it is known to provide the piece goods with an individualizing code (e.g. bar code) already during storing same into a warehouse. Correspondingly marked piece goods can be removed from the order container and, for example, can be checked with a hand-held scanner. However, this procedure is very time and work-consuming at both the goods input as well as at the goods output, since each of the piece goods is taken in hand several times.

Therefore, there are proposals for a semi-automatic checking. A checking operation is substantially composed of two stages. In a first stage the piece goods of a collected order need to be separated for being identified automatically in a second stage. The first stage is performed manually. The order containers are manually emptied, and the piece goods are subsequently given manually one-by-one on a conveying device, which transports the separated piece goods to an automatic scanner, which unambiguously identifies the piece goods, for example, by their bar codes and verifies accuracy thereof on the basis of the picking order. Such a semi-automatic checking station is shown in the German utility model DE 20 2009 002 919 U1.

The use of manual work is disadvantageous, since it takes much time and working force is expensive. Therefore, there is a need for a fully automatic solution, wherein not only the second stage but also already the first stage of the separation happens in an automated manner.

### SUMMARY OF THE INVENTION

Therefore, it is an object of the present invention to automate the first stage reliably such that a downstream automatic identification of separated piece goods is reliably ensured. The piece goods need to be transferred individually to the automatic identification device for allowing carrying out the identification reliably. For example, it may not happen that two piece goods are provided at the same time for the purpose of identification. In this case, identification errors can occur because either only one of the piece goods is identified or none of the two piece goods can be identified unambiguously, i.e. correctly.

According to a first aspect of the invention it is proposed a device for separating a quantity of piece goods, which are provided in a geometrically disordered state, into an ordered row, in which the piece goods are lined up one behind the other. The device comprises: a conveyor having a receiving zone and a discharging zone, wherein the conveyor comprises a conveying surface on which the piece goods are transported in a main-conveying direction downstream to the receiving zone which is preferably arranged at an upstream end of the conveyor, and wherein the discharging zone is arranged at a downstream end of the conveyor; and a guiding device along which the piece goods are conducted in the main-conveying direction to the discharging zone; wherein the conveyor comprises a plurality of conveyor segments, the longitudinal extensions thereof being orientated obliquely relative to the main-conveying direction, and wherein each of the downstream conveyor segments is operated at a higher velocity than an upstream conveyor segment located adjacent thereto.

According to a second aspect of the invention it is proposed a separating device for separating a quantity of piece goods, which are provided in a geometrically disordered state and which were collected in accordance with a picking order, into a row so that the piece goods are lined up one behind the other, comprising: a conveyor having a receiving zone and a discharging zone, wherein the conveyor comprises a conveying surface on which the piece goods are trans-ported in a main conveying direction from the receiving zone downstream to the discharging zone, wherein the discharging zone is arranged at a downstream end of the conveyor; and a guiding device arranged such that the piece goods are conducted in the main conveying direction to the discharging zone; wherein the conveyor further comprises a plurality of conveyor segments each having a longitudinal extension, wherein the conveyor segments are arranged side-by-side along the main conveying direction, wherein each of the longitudinal extensions is orientated obliquely relative to the main conveying direction, and wherein each downstream located one of the conveyor segments is operated at a higher velocity than the one of the conveyor segments being located upstream adjacent thereto.

With the increasing velocity in the main-conveying direction it is possible to draw apart piece goods being located at the same level so that all of them are arranged in a row one behind the other at the end of the conveyor, without piece goods arriving parallel next to one another, i.e. at the same level, in the discharging zone. This subsequent ranking of the piece goods is of large advantage with regard to a later identification and registration of the piece goods. Incorrect identifications can thus be avoided.

The conveyor segments cause, by the oblique arrangement thereof, both the transport of the piece goods in the main-conveying direction and overtaking processes of piece goods arranged side-by-side. In this case, the piece good being located further to the outside reaches the next conveyor segment earlier than the inner piece good which contacts the guiding device. During transition of the conveyer segments, the outer piece good experiences acceleration earlier than the inner piece good and thus covers a larger path in the same time which contributes to the overtaking process of the piece goods. The conveying velocities of the conveyor segments can be respectively divided into a velocity component being orientated parallel to the main-conveying direction and another velocity component being orientated perpendicular to the guiding device. In this way it is possible that all of the disordered piece goods are moved towards the guiding device while being (overtakingly) transported simultaneously in the main-conveying direction.

With a preferred embodiment each of the conveyor segments is a linear conveyor, i.e. a straight conveyor.

Linear conveyors can be arranged easily in parallel and adjacent to each other for defining an as continuous as possible conveying surface, i.e. conveying plane. In addition, the technical structure of a linear conveyor is simpler than the one of a curved conveyor. Wear and abrasion are less strongly pronounced with linear conveyors. Guiding elements (projections, grooves, etc.) can be forgone.

In addition, it is advantageous to arrange the conveyor segments parallel to one another.

In this manner it is possible, without problems, to arrange many conveyor segments side-by-side. The conveyor segments are arranged, in particular spaced apart, along their longitudinal direction for defining an as continuous as possible conveying plane.

Preferably, the conveyor segments are arranged laterally adjacent, in particular directly.

Thus, space, or the area, between adjacent ones of the conveyor segments is minimized. The probability that one of the piece goods gets jammed, i.e. is not transported further, between two neighboring ones of the conveyor segments is correspondingly reduced. The denser adjacent ones of the conveyor segments are located to one another, the clearer the velocity jumps are further defined between adjacent ones of the conveyor segments. The velocity jumps cause “overtaking processes” between chaotically provided piece goods, in order to allow lining-up of the piece goods one behind the other.

With another preferred embodiment the conveyor segments define the conveying surface.

Conveying sections of the conveyor then consist only of the obliquely arranged conveyor segments. Further, for example, bridging conveying sections are not provided in this instance.

It is also advantageous if each of the conveyor segments comprises an endless rotating belt conveyor.

Endless rotating belt conveyors are controllable without any problem with regard to their velocities, for example, by means of a driven return pulley, wherein the control effort is minimal. The velocity can be set variably and changed continuously. Alternatively, other conveyor types such as conveyors having driven rollers or the like can be used as well. Belts can be maintained easily and represent standard components in order-picking systems.

With another preferred embodiment all of the conveyor segments are of an identical type.

The use of the same conveyor type, in turn, facilitates the maintenance. Spare parts need to be on stock for one conveyor type only.

With another particular embodiment each of the conveyor segments has a width smaller than a width of the conveyor itself.

With decreasing width more velocity jumps can be provided for each unit length of the transportation path. The more velocity jumps are provided, the higher the probability is that the originally disordered piece goods are lined up one behind the other, without the piece goods being arranged laterally adjacent to each other.

With another preferred embodiment the main conveying direction is orientated parallel relative to the course of the guiding device.

Also the guiding device extends along the conveying path so that the angles and velocity jumps of the conveyor segments remain constant.

Further, it is preferred to provide a leveling device.

By means of the leveling device the piece goods, which are unintentionally lying on top of each other, can all be brought on the conveying surface within the discharging zone. In this way it is avoided that two piece goods simultaneously enter the downstream located automatic identification device. The piece goods reach the identification device one behind the other, but not on top of each other or side-by-side.

Further, it is advantageous if the leveling device represents a step in the conveyor.

At the step, the piece goods fall onto another height level so that piece goods, which lie on top of each other, are separated. Also in this case it is caused that the piece goods, which are lying on top of each other, can be arranged one after the other, after having passed the step.

According to a third aspect of the invention an order-picking checking station is proposed which comprises at least one separating device in accordance with the present invention and a transversal conveyor, a container-emptying station and/or an automatic piece-goods identification device.

According to a fourth aspect of the invention it is proposed an order-picking checking station comprising a separating device for separating a quantity of piece goods, which are provided in a geometrically disordered state and which were collected in accordance with a picking order, into a row so that the piece goods are lined up one behind the other, the separating device comprising: a conveyor having a receiving zone and a discharging zone, wherein the conveyor comprises a conveying surface, on which the piece goods are transported in a main conveying direction downstream from the receiving zone to the discharging zone, wherein the discharging zone is arranged at a downstream end of the conveyor; and a guiding device arranged such that the piece goods are conducted in the main conveying direction to the discharging zone; wherein the conveyor comprises a plurality of conveyor segments each having a longitudinal extension, wherein the conveyor segments are arranged side-by-side along the main conveying direction, wherein each of the longitudinal extensions is orientated obliquely relative to the main conveying direction, and wherein each downstream located one of the conveyor segments is operated at a higher velocity than the one of the conveyor segments being located upstream adjacent thereto.

The separating station of the present invention can be used with a checking station in an order-picking system. Both of the above-mentioned stages are carried out in a fully-automated manner. No manual work is required for checking collected picking orders.

According to a fifth aspect of the invention it is proposed a method for lining up piece goods one behind the other, which are provided in a geometrically disordered state, comprising the steps of: providing the piece goods on a conveyor, which comprises a plurality of conveyor segments being orientated obliquely relative to the main conveying direction; and operating the conveyor segments at different velocities such that a downstream conveyor segment is operated at a higher velocity than an upstream conveyor segment being located adjacent thereto.

According to a sixth aspect of the invention it is proposed a method for lining up piece goods one behind the other by means of a separating device for separating a quantity of the piece goods, which are provided in a geometrically disordered state and which were collected in an order container in accordance with a picking order, into a row so that the piece goods are lined up one behind the other, the separating device comprising a conveyor having a receiving zone and a discharging zone, wherein the conveyor comprises a conveying surface, on which the piece goods are transported in a main conveying direction downstream from the receiving zone to the discharging zone, wherein the discharging zone is arranged at a downstream end of the conveyor; and a guiding device arranged such that the piece goods are conducted in the main conveying direction to the discharging zone; wherein the conveyor further comprises a plurality of conveyor segments each having a longitudinal extension, wherein the conveyor segments are arranged side-by-side along the main conveying direction, wherein each of the longitudinal extensions is orientated obliquely relative to the main conveying direction, and wherein each downstream located one of the conveyor segments is operated at a higher velocity than the one of the conveyor segments being located upstream adjacent thereto.

Hence, the conveying velocities of the conveyor segments increases with increasing covered conveying path. Since the conveyor segments are orientated obliquely relative to the main conveying direction, the conveying velocity of each of these segments can be divided into a component parallel relative to the main conveying direction and into a component perpendicular relative to the main conveying direction. Since the respective conveying-segment velocity also increases with increasing conveying path, the corresponding conveying-velocity components increase proportionally. Hence, again and again there will be jumps in the conveying velocity, allowing the piece goods to be pulled apart in the main conveying direction, this means an increase in the distances between the piece goods.

Due to the oblique arrangement of the conveyor segments the piece goods can be pulled apart as well, i.e. the distance between can be increased since one of the piece goods enters earlier the region of a downstream conveyor segment. In this manner, displacement of piece goods in the main conveying direction, being originally located at the same level, is generated which can be sufficient for arranging the piece goods, which were originally located at the same level, one behind the other at the end of the conveyor. In this context, rotational movements about an axis perpendicular relative to the conveying surface can occur. However, these rotational movements are acceptable, since the downstream piece-goods identification device operates independently of an orientation of the piece goods. Preferably, the piece-goods identification device scans six sides (e.g. front, back, left, right, top and/or bottom) of the piece goods so that identification features such as bar codes, RFID-tags, etc. can be recognized reliably.

### BRIEF DESCRIPTION OF THE DRAWINGS

It is clear that the above-mentioned and still to be explained below features cannot only be used in the respectively given combination but also in other combinations or alone without departing from the scope of the present invention.

Embodiments of the invention are shown in the drawings and will be explained in more detail in the description below, wherein:

FIG. 1 shows a perspective view of an order-picking checking station having two separating devices in accordance with the present invention;

FIG. 2 shows a schematic side view of the order-picking checking station of FIG. 1;

FIG. 3 shows a schematic top view of the order-picking checking station of FIG. 1;

FIG. 4 shows a top view of another separating device in accordance with the present invention including a graphical explanation of the different conveying velocities;

FIG. 5 shows a top view of another embodiment of a separating device in accordance with the present invention;

FIG. 6 shows again a top view of still another embodiment of a separating device in accordance with the present invention having several components;

FIG. 7 shows a perspective illustration of an exemplary leveling device; and

FIG. 8 shows a flow chart of a method in accordance with the present invention.

### PREFERRED EMBODIMENTS OF THE INVENTION

In the description of the figures below identical features will be designated by identical reference numerals. A running index indicates that an element is present several times. Modified elements will be designated by a stroke.

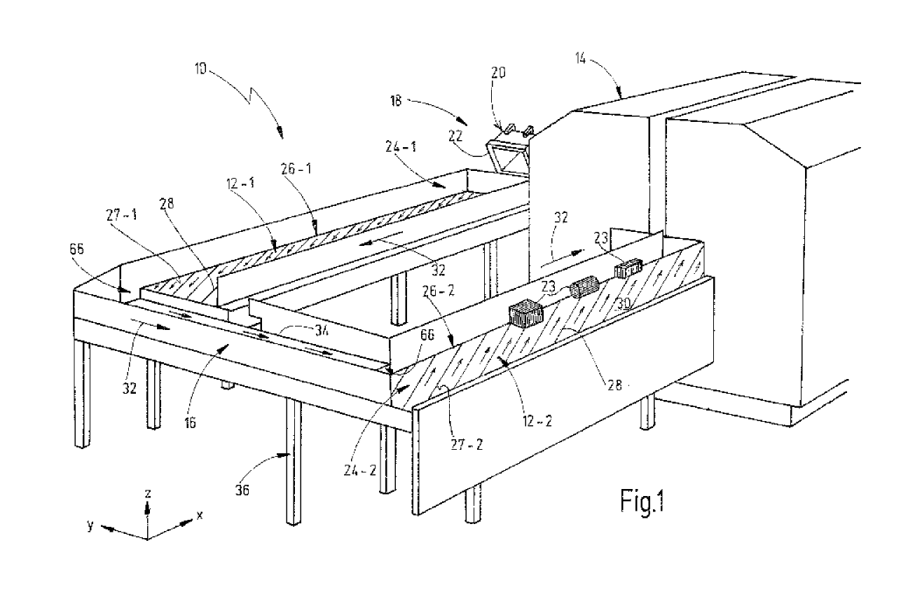

FIG. 1 shows a perspective view of an order-picking checking station 10 (hereinafter also designated briefly as “checking station”). The checking station 10 is fully automated, i.e. the checking station 10 operates fully independent without operators for manual support.

The checking station 10 comprises one or more separating devices 12. In the example of FIG. 1 two separating devices 12-1 and 12-2 are shown. The exemplary separating devices 12-1 and 12-2 are conveying piece goods 23 to a piece-goods identification device 14. The separating devices 12-1 and 12-2 can be connected to each other by means of a cross conveyor 16 or another conveying medium.

In the present case, one exemplary (container) emptying station 20 is provided at an emptying point 18, which preferably is arranged at an upstream end of the first separating device 12-1, for emptying order containers, or collecting containers, 22 into a receiving zone 24-1 of the device 12-1. In this case, the emptying process occurs in an automated manner. However, the emptying process can also be performed manually, wherein the piece goods 23 typically fall chaotically, i.e. in a geometrically disordered state, onto the separating device 12-1.

The separating devices 12-1 and 12-2 comprise a conveyor 26-1 and 26-2, respectively. Each of the conveyors 26 defines a conveying surface, or conveying plane, 27 on which the piece goods 23 are transported by means of conveyor segments 28. The conveyor segments 28 are arranged, for example, in parallel, and preferably directly adjacent to each other. It is clear that clearance is provided between the conveyor segments 28 in order to avoid contact of directly opposing conveyor segments at front faces thereof. Preferably, the distances between the conveyor segments 28 are to be kept as small as possible. For example, the conveyor segments 28, which are orientated obliquely relative to a main conveying direction 32 of the conveyors 26, are endless rotating belt conveyors. It is clear that, other conveyor types can be used such as motor rollers, chain conveyors, belt conveyors or the like.

The conveyor 26 transports the piece goods 23 substantially in the main-conveying direction 32, which in FIG. 1 is exemplarily orientated parallel to the longitudinal extensions of the conveyors 26-1 and 26-2. The piece goods 23 are also transported parallel relative to the main-conveying direction, i.e. relative to the longitudinal extension, in the region of the cross conveyor 16, which can also be a belt conveyor. The cross conveyor 16 is a linear conveyor 34, i.e. a conveyor transporting the piece goods in a straight direction. In this sense the conveyor segments 28 are also linear conveyors 34, which are adapted to transport conveying goods 23 along a longitudinal extension thereof. A step can be provided between the separating device 12-1 and the cross conveyor 16. The same applies with regard to the material flow transition between the cross conveyor 16 and the second separating device 12-2. The separating device 12-2 ends at, or in, the piece-goods identification device 14, wherein in FIG. 1 merely a housing thereof is shown.

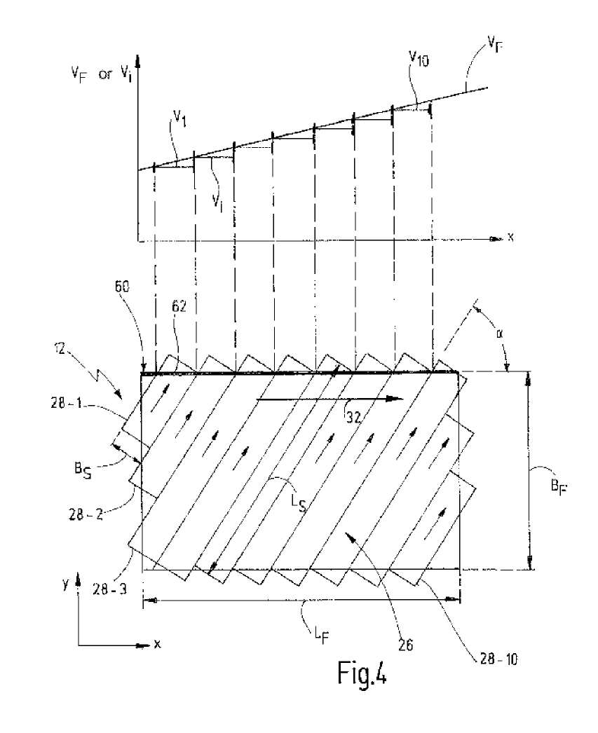

It is clear that arbitrarily many separating devices 12 can be arranged subsequently with regard to material flow, in order to transport the piece goods 23 from an emptying point 18 to the piece-goods identification device 14. The piece goods 23, which are chaotically overturned onto the conveying surface 27-1 of the conveyor 26-1 into the receiving zone 24-1, are transported on their way to the piece-goods identification device 14, due to the oblique orientation of the conveyor segments 28, towards one of the outer limitation walls of the separating device 26-1. The piece goods 23 are also pulled apart in the main conveying direction 32, i.e. the distance of the piece goods 23 along the main conveying direction 32 gets bigger and bigger during the transport of the piece goods 23 on the conveyor 26 since the conveyor segments 28 are operated at different conveying velocities. The conveying velocities of the individual conveyor segments 28 are increasing in a downstream direction. This will be explained in more detail with reference to FIG. 4.

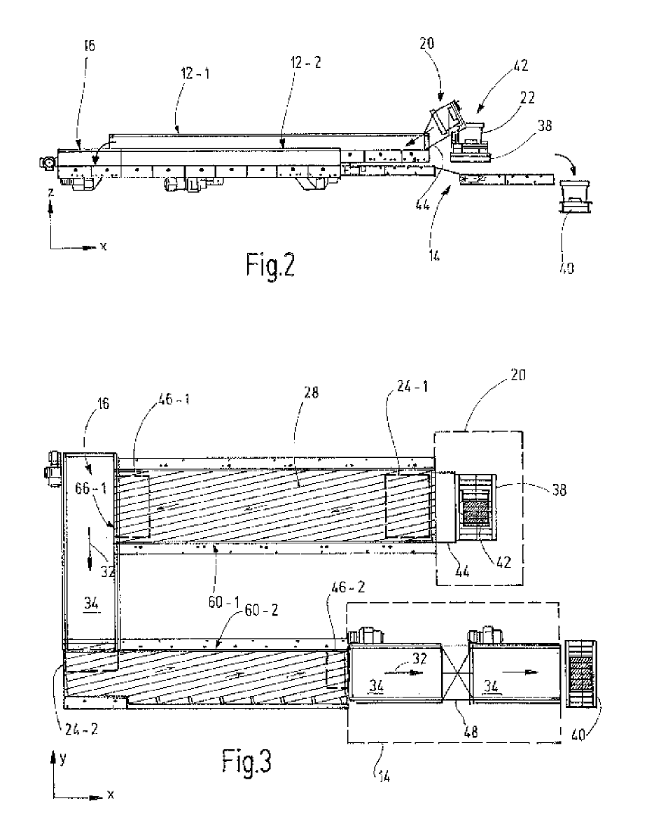

In FIG. 2 a simplified side view of the order-picking checking station 10 of FIG. 1 is shown, wherein a frame 36, on which the conveyors 26 and 16 are arranged, is not shown for the sake of simplicity. The same applies with regard to the housing of the piece-goods identification device 14. FIG. 2 shows that the separating devices 12-1 and 12-2 are arranged at different levels of height. Full order containers 22 are supplied to the container-emptying station 20 via an order-container conveyor 38. It is clear that, on principle, any arbitrary other load support, instead of a container, can be used (e.g. a tray).

The order-container conveyor 38 supplies fully loaded order containers 22 to the container-emptying station 20. A completely loaded order container 22 is to be understood hereinafter as an order container which contains all of the piece goods, with regard to number and type, which are assigned thereto in accordance with one picking order. Typically, one picking order comprises a number of order lines. Each of the order lines represents a type of piece good and indicates the number of the desired type. A superordinated central computer (not shown) assigns one or more order containers 22 to each of the picking orders, dependent on scale of the order. As soon as all of the piece goods have been collected, i.e. picked, in an upstream picking stage (e.g. in accordance with the “goods-to-man” principle or the “man-to-goods” principle), the full order containers 22 are transported to the order-picking checking station 10 of FIG. 1 for final inspection. In the checking station 10 it is checked whether the collected piece goods 23 match the piece goods 23, which are determined by the picking order, with regard to type, number, batch, expiration date, etc. Of course, the checking station 10 can also be operated without order management. In the simplest case, checking starts at time t0, or at one piece good S0, and all of the piece goods 23 are counted and scanned up to the time tn, or up to a piece good Sn.

For supplying the full order containers 22 on the conveying surface 27, the container-emptying station 20 comprises a pivotal mechanism, or tilting mechanism, 42. As soon as content of the full order container 22, i.e. the collected piece goods 23, is given onto the separating device 26-1 by means of the pivotal mechanism 42, the pivotal mechanism 42 rotates back the order container 22, which is now empty, on an order-container conveyor 38. The container-emptying station 20 comprises, for example, a chute 44, in order to bring the piece goods 23 reliably to the receiving zone 24-1 of the first separating device 12-1. The order-container conveyor 38 can transport the empty order container 22 to an order-container conveyor 40, which passes an output end of the piece-goods identification device 14, in order to re-fill the empty order containers 22 with the corresponding piece goods 23. Individualizing identification features such as bar codes of the piece goods 23 are read in the piece-goods identification device 14 and data comparison is initiated. If the checked piece goods 23 match the piece goods 23, which are predefined in accordance with the order, an empty order container 22, or any other order container 22, on the order-container conveyor 40 is filled with the checked piece goods 23 and subsequently transported away, for example, to a shipping area of the order-picking system in which the order-picking checking station 10 is arranged. If a picking error is determined, the order container 22 can also be filled again with the piece goods 23 associated therewith, and can be transported subsequently into a correction station (not shown), or once again to post picking in a picking region which is not shown in more detail here.

It is clear that the feeding order-container conveyor 38 can comprise the discharging order-container conveyor 40. The order-container conveyors 38 and 40 can, however, represent separated conveyor loops, which are connected to each other by means of a switch or the like. The order-container conveyor 38 or 40 is shown, for example, in terms of a roller conveyor. It is clear that the order-container conveyors 38 and 40 can be of any other conveyor type (e.g. belt conveyor, chain conveyors, etc.).

Both, the container-emptying station 20 and the piece-goods identification device 14 are merely shown in terms of broken lines in the top view of FIG. 3.

The piece-goods identification device 14 can comprise, for example, in an interior thereof which is not shown in FIG. 1, two adjacent linear belt conveyors 34, which have arranged therebetween, for example, an Plexiglass plate 48. In the region of the Plexiglass plate 48, which preferably bridges a slope between the belt conveyors 34 of the piece-goods identification device 14, a plurality of scanners (not shown) can be arranged, which scan preferably all four sides of piece good 23 perpendicularly relative to the main conveying direction 32. Since all of the piece goods 23 have been lined up one behind the other in a row along the separating devices 12-1 and 12-2, so that none of the piece goods 23 is fed to the piece-goods identification device 14 laterally to another one, the bar code can be read without bigger efforts in the region of the Plexiglass plate 48 (perpendicular relative to the transport direction). It is clear that other transparent materials can be used instead of Plexiglass. Also, it is not necessarily required to use four scanners. More or less scanners can be used. Less scanners are required if the other sides of the piece goods, for example, are projected by means of mirrors into the existing scanner(s).

The path of the piece goods 23 from the container-emptying station 20 to the output end of the piece-goods identification device 14 is described subsequently on the basis of the example of the FIGS. 1-3.

Full order containers 22 are tilted chaotically into the receiving zone 24-1 of the first separating device 12-1. Each of the conveyor segments 28 is operated at a different conveying velocity vᵢ. The conveying velocities increase in a downstream direction. The piece goods 23 are transported due to the oblique orientation of the conveyor segments 28 to the lower side of separating device 12-1, which is preferably orientated perpendicularly to the conveying surface 27-1. The piece goods 23 in the discharging zone 46-1 are handed over to the cross conveyor 16. Since the cross conveyor 16 is arranged deeper than the first separating device 12-1 (cf. also FIG. 2), the piece goods 23 fall onto the transversal conveyor 16. In this manner it is possible to separate piece goods 23 in height from each other, which are lying on top of each other after the full order containers 22 have been emptied. The cross conveyor 16 transports the handed over piece goods 23 to the receiving zone 24-2 of the second separating device 12-2. Also in this case the transition from the cross conveyor 16 to the conveyor 26-2 comprises a difference in height for ensuring once again, if possible, that the piece goods 23 in the region of the second separating device 12-2 are not arranged on top of each other. In this case, the second separating device 12-2 is structured functionally like the first separating device 12-1. Then, the all of the piece goods 23 are lined up one behind the other along an “upper” side in the discharging zone 46-2 on the second separating device 26-2, and the piece goods 23 are handed over to the piece-goods identification device 14. The individual piece goods 23, which are arranged in terms of a row one behind the other, are scanned in the piece-goods identification device 14 for being checked subsequently in terms of data, based on the associated picking order. Then, the checked piece goods 23 are given to the, preferably already waiting, empty order container 22 at the output end of the piece-goods identification device 14. It is clear that the empty order container 22 does not need to be identical to the full order container 22, which was emptied before. The central computer can also assign a (physically) different order container 22 to the picking order, i.e. the quantity of the checked piece goods 23. Further, it is clear that the piece-goods identification device 14 can be provided additionally with a discharging device, which is presently not shown in further detail, in order to discharge wrongly picked piece goods 23 already in the region of the piece-goods identification device 14. This can be advantageous if the picking order has been processed correctly with regard to the rest. In this case, the order container 22 can be transported immediately to the shipping area without a need to bring same to a separate correction station.

FIG. 4 shows a top view on another exemplary separating device 12 in accordance with the present invention in the lower region of the figure. In the upper region of FIG. 4 a velocity vs. path diagram is shown, in order to explain the conveying velocities clearer.

The separating device 12 of FIG. 4 comprises, for example, ten conveyor segments 28-1 to 28-10, longitudinal extensions of which form an angle a with the main-conveying direction 32. The angle a preferably is in a range of 5 to 85°. Acute angles are preferred, since in this case less conveyor segments 28 for each unit path in the direction X are required. Huge angles a can be advantageous, because in this case many velocity jumps occurred during transport along the main-conveying direction 32.

The conveyer segments 28-1 to 28-10 are arranged in parallel to each other and comprise an as small as possible distance to each other. It is clear that the conveyor segments 28 can also be further distanced to each other. However, the distance should be smaller than a smallest side length of one of the piece goods 23, which is transported on the separating device 12, in order to prevent that the smallest piece good 23 gets jammed between adjacent ones of the conveyor segments, i.e. can get settled there and is not transported further.

The separating device 12 of FIG. 4 further comprises a guiding device 60 which in the present case comprises, for example, a straight conducting surface, or conducting wall, 62 which is orientated, for example, perpendicularly to the conveying surface, or the conveying plane. The conveyor segments 28 convey the piece goods 23, which were given onto the conveyor segments 28 at their respective upstream end, towards the conducting surface 62. When the piece goods 23 arrive at the conducting surface 62 they bump against same and are subsequently transported in the main-conveying direction 32 only, i.e. along the conducting surface.

Each of the conveyor segments 28-1 to 28-10 is operated at a different conveying velocity vᵢ, wherein the conveying velocity vᵢ increases in a downstream direction. This is illustrated in the velocity vs. path diagram, which is presented above the separating device 12 of FIG. 4. The conveying velocities vᵢ of the individual segments 28 are arranged in terms of steps. An enveloping line of the discrete conveying velocities vᵢ can be expressed in terms of a straight line, which in turn represents the conveying velocity v_{F} of the conveyor 26. The conveying velocity v_{F} of the conveyor 26 increases with increasing path length in the direction X, i.e. in a downstream direction. In the example of FIG. 4 the conveying velocities vᵢ of adjacent conveyor segments 28 increase uniformly. It is clear that also non-uniform increments of conveying velocities are possible as long as the conveying velocity vᵢ of one of the conveyor segments 28ᵢ is lower than the conveying velocity vᵢ₊₁ of a downstream conveyor segment 28ᵢ₊₁ adjacent thereto. The increment in velocity is linear in the example of FIG. 4. However, it could also be exponential or the like. The smallest velocity could be, for example, 0.29 m/s. The velocity increment between adjacent conveyor segments can be, for example, 0.03 m/s.

Further it is clear that the entire conveying surface 27 does not need to be covered by the conveyor segments 28. In the example of FIG. 4 the conveying surface is indicated by means of a rectangle, which is surrounded by a solid line. The conveyor 26 of FIG. 4 comprises, for example, a width B_{F} and a length L_{F}. The conveyor segments 28-1 to 28-10 respectively comprise a width B_{S}, which can be identical for all of the conveyor segments 28. The width B_{S} is preferably smaller than the width B_{F}. The lengths L_{S} of the conveyor segments 28 can be identical or different. In the example of FIG. 4 the conveyor segments 28-4 to 28-8 are formed with identical lengths. The more of the conveyor segments 28 are formed identically, the less complex the entire system is, since the conveyors, which might be very small, at the upstream end and at the downstream end can be expensive in terms of construction.

With reference to FIG. 5 another embodiment of a separating device 12 in accordance with the present invention is shown.

The separating device 12 of FIG. 5 comprises conveyor segments 28, which are differently broad. The upstream conveyor segments 28-1 to 28-4 comprise a first width B_{S1}, which is constant and broader than a width B_{S2} of the downstream conveyor segments 28-5 to 28-13. The width B_{S2} is, for example, half of the width B_{S1}. It is clear that different width relationships can be selected. The conveyor segments 28 can also have different inclination angles a relative to each other and can be oriented differently among each other. In the present case, however, all of the inclination angles a have the same size so that the conveyor segments 28 are always oriented parallel to each other. This does not need to be this way.

The guiding device 60 of the separating device 12 of FIG. 5 comprises two conducting surfaces 62-1 and 62-2 enclosing an angle β of 155°, for example. If the piece goods 23 reach a transferring zone between the conducting surfaces 62-1 and 62-2, the inclination angle α1 changes to α2. The distribution of the individual velocity components vᵢ of the conveyor segments 28 changes with the change of the inclination angle α, as exemplarily indicated in the upper half of FIG. 4. Also the width B_{S} of the conveyor segments 28 has influence on the distribution and magnitude of the conveying velocities vᵢ of the conveyor segments 28. The enveloping line v_{F} of FIG. 5 looks differently than the enveloping line v_{F} of FIG. 4. The inclination angle a as well as the width B_{S} of the conveyor segments 28 are exemplary parameters, which can influence the sorting of the piece goods 23 along the guiding device 60. The friction coefficient of the surface of the conveyor segments 28 represents another parameter. The surfaces of the conveyor segments 28 can have, for example, different friction coefficients for causing, in this way, rotations of the piece goods 23 relative to the guiding device 60.

Further, the (geometrical) distribution of the piece goods 23 in the receiving zone has influence on the quality of the sorting process, i.e. the quality and the velocity of the lining up of the piece goods one behind the other in order to form one single row of piece goods. A chaotic, i.e. geometrically disordered, quantity of piece goods 23 is shown in FIG. 5 in the left lower corner of the conveyor 26, the piece goods being distributed along an imaginary virtual line 64 over the widths B_{S} of the conveyor segments 28. FIG. 5 serves for explaining the point in time when the piece goods 23 are handed over from a full load support onto the conveyor 26 of the separating device 12. The broader the piece goods 23 are distributed along the virtual line 64 during the handing-over process in the transferring zone 24, the better the sorting result in the discharging zone 46 will be. An explanation for this is to be seen, for example, in that the piece goods 23 on the conveyor segment 28-4 will already have overtaken the piece goods 23 on the conveyor segment 28-3 in the longitudinal direction of the conveyor segments 28 by the time they have reached the conducting surface 62-1. In this sense the piece goods 23 on the conveyor segment 28-3 then have already moved behind the piece goods 23 on the conveyor segment 28-4. After having passed the entire conveyor segments 28 all of the piece goods 23 are lined up one behind the other in one single row along the conducting surface 62-2.

The guiding device 60 of FIG. 5 can be provided further with projections 64 at one or both conducting surfaces 62-1 and/or 62-2. The projections 64 serve for bringing the piece goods 23, which are still moved side-by-side over the conveyor 26, one behind the other. The projections 64 are provided, for this purpose, preferably in transferring zones between adjacent conveyor segments 28. The projections 64 are dimensioned such that no piece-good accumulations occur. The projections 24 are formed rather small relative to the overall dimension of the guiding device 60 so that accumulations are prevented reliably. The projection 64 shown in FIG. 5 comprises, for example, a base area having a triangle shape. Other base areas are possible. The height (direction Z) can be selected freely.

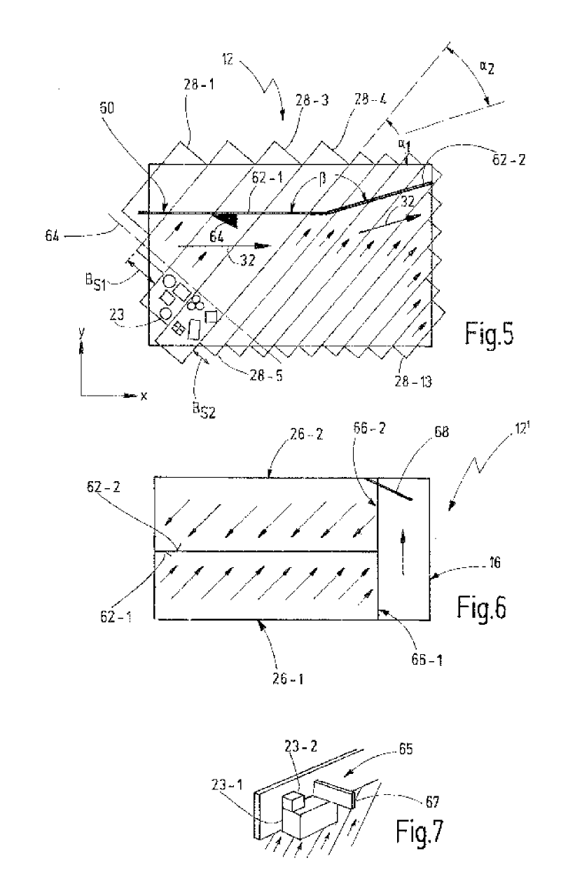

If the length of the separating device 12 of FIG. 5 is not sufficient for bringing all of the piece goods 23 reliably into one single row along the guiding device 60, then several separating devices 26 can be connected together with regard to material flow, or can be connected to each other. Such a separating device 12′ is shown in FIG. 6. The separating device 12′ of FIG. 6 comprises two separating devices 26-1 and 26-2 as well as a connecting linear cross conveyor 16. A first step 66-1 is provided between the conveyor 26-1 and the cross conveyor 16. Further, a deflecting surface 68 can be provided at a downstream end of the cross conveyor 16 for deflecting the piece goods 23 from the cross conveyor 16 onto the conveyor 26-2. It is clear that the conveyors 26-1 and 26-2 respectively comprise a plurality of conveyor segments 28, which are not shown in more detail here. The conveyor segments 28 have conveying velocities which steadily increase in the downstream direction.

The optional stages 66-1 and 66-2 serve for the purpose of bringing the piece goods 23, which are possibly still arranged on top of each other, onto a unitary level of height.

With reference to FIG. 7 a leveling device 65 in terms of a flexible comb 67 is shown, which is attached to the guiding device 60. In the present case, the comb 67 projects, for example, perpendicular from the conducting surface 62 and is attached to the conducting surface 62 flexibly so that the piece goods 23 cannot become wedged together. In this manner it is ensured that no piece-good accumulation occurs on the conveyor 26. Several combs 67 can be attached in different heights so that first piece goods 23-1 can pass below the combs 67 without any problems, whereas piece-good stacks, as indicated in FIG. 7 by means of additional piece goods 32-2, are resolved.

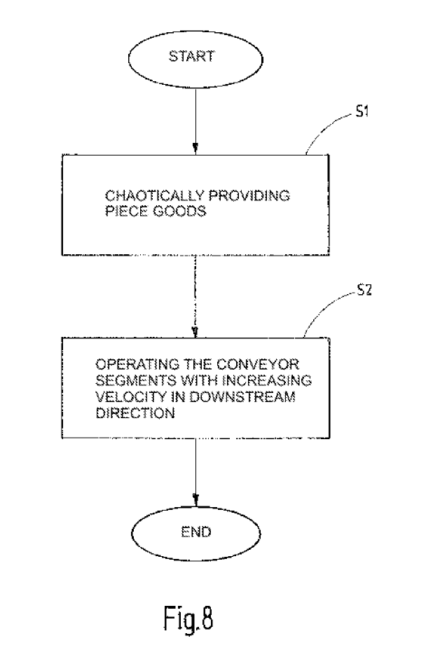

In FIG. 8 a flow chart of a method in accordance with the invention is shown. In a first step S1 the piece goods 23 are provided on the conveyor 26, which comprises a plurality of conveyor segments being orientated obliquely relative to a main conveying direction 32. In another step S2 the conveyor segments 28 are operated at different velocities vᵢ so that a downstream conveyor segment is operated at a higher velocity than an upstream conveyor segment being located adjacent thereto.

It is clear that the above described fully-automated process can be partially supported manually. For example, there might be situations in which the separation still does not function without errors. In this case, manual interventions might be possible, for example, for resolving a piece-good accumulation.

Further, it is clear that an emptying point 20 is not necessarily required. Thus, a conveyor for individual piece goods can be coupled directly to the checking station 10. Alternatively, the checking station 10 can form part of an order-picking work station. In this case, the load support (container, carton, etc.) can be omitted. In principle, the load supports can be omitted.

Therefore what we claim is:

1. A separating device for separating a quantity of piece goods, which are provided in a geometrically disordered state and which were collected in accordance with a picking order, into a row so that the piece goods are lined up one behind the other, comprising:
a conveyor having a receiving zone and a discharging zone, wherein the conveyor comprises a conveying surface on which the piece goods are transported in a main conveying direction from the receiving zone downstream to the discharging zone, wherein the discharging zone is arranged at a downstream end of the conveyor; and
a guiding device, arranged such that the piece goods are conducted in the main conveying direction to the discharging zone;
wherein the conveyor comprises a plurality of conveyor segments each having a longitudinal extension, wherein the conveyor segments are arranged side-by-side along the main conveying direction, wherein each of the longitudinal extensions is orientated obliquely relative to the main conveying direction, and wherein each downstream located one of the conveyor segments is operated at a higher velocity than the one of the conveyor segments being located upstream adjacent thereto.

2. The separating device of claim 1 wherein the receiving zone is arranged at an upstream end of the conveyor.

3. The separating device of claim 1 wherein each of the conveyor segments is configured to be operated at a specific velocity, wherein each of the specific velocities is selected so that the piece goods in the discharging zone are distanced to each other in the main conveying direction.

4. The separating device of claim 1 further comprising a leveling device which is configured to separate piece goods which are lying on top of each other, in a height direction.

5. The separating device of claim 4 wherein the leveling device is a step in the conveyor so that piece goods, which are stacked on top, fall when they pass the step.

6. The separating device of claim 1 wherein the guiding device comprises a conducting surface, which is oriented parallel to the main conveying direction and perpendicular to the conveying surface.

7. The separating device of claim 6 wherein the conducting surface comprises at least one projection reaching into a region of the conveying surface, the at least one projection being substantially orientated transversely relative to the main conveying direction.

8. The separating device of claim 1 wherein the conveyor segments are arranged parallel to each other.

9. The separating device of claim 1 wherein the conveyor segments are arranged laterally adjacent to each other.

10. The separating device of claim 1 wherein the conveyor segments define the conveying surface.

11. The separating device of claim 1 wherein each of the conveyor segments comprises an endless rotating belt conveyor.

12. The separating device of claim 1 wherein each of the conveyor segments is of an identical type.

13. The separating device of claim 1 wherein each of the conveyor segments comprises a width which is smaller than a width of the conveyor.

14. An order-picking checking station comprising a separating device for separating a quantity of piece goods, which are provided in a geometrically disordered state and which were collected in accordance with a picking order, into a row so that the piece goods are lined up one behind the other, the separating device comprising:
a conveyor having a receiving zone and a discharging zone, wherein the conveyor comprises a conveying surface, on which the piece goods are transported in a main conveying direction downstream from the receiving zone to the discharging zone, wherein the discharging zone is arranged at a downstream end of the conveyor; and a guiding device arranged such that the piece goods are conducted in the main conveying direction to the discharging zone; wherein the conveyor comprises further a plurality of conveyor segments each having a longitudinal extension, wherein the conveyor segments are arranged side-by-side along the main conveying direction, wherein each of the longitudinal extensions is orientated obliquely relative to the main conveying direction, and wherein each downstream located one of the conveyor segments is operated at a higher velocity than the one of the conveyor segments being located upstream adjacent thereto.

15. The order-picking checking station of claim 14 further comprising a cross conveyor.

16. The order-picking checking station of claim 14 further comprising a container-emptying station.

17. The order-picking checking station of claim 14 further comprising an automatic piece-good identification device.

18. A method for lining up piece goods one behind the other by means of a separating device for separating a quantity of the piece goods, which are provided in a geo-metrically disordered state and which were collected in an order container in accordance with a picking order, into a row so that the piece goods are lined up one behind the other, the separating device comprising a conveyor having a receiving zone and a discharging zone, wherein the conveyor comprises a conveying surface, on which the piece goods are transported in a main conveying direction downstream from the receiving zone to the discharging zone, wherein the discharging zone is arranged at a downstream end of the conveyor; and a guiding device arranged such that the piece goods are conducted in the main conveying direction to the discharging zone; wherein the conveyor further comprises a plurality of conveyor segments each having a longitudinal extension, wherein the conveyor segments are arranged side-by-side along the main conveying direction, wherein each of the longitudinal extensions is orientated obliquely relative to the main conveying direction, and wherein each downstream located one of the conveyor segments is operated at a higher velocity than the one of the conveyor segments being located upstream adjacent thereto, comprising the steps of:
providing the piece goods in a geometrically disordered state by tilting them from the order container into the receiving zone of the; and
operating the conveyor segments with different velocities such that a downstream located one of the conveyor segments is operated at a higher velocity than an upstream located one of the conveyor segments arranged upstream adjacent thereto so that the piece goods are distanced to each other in the discharging zone along the main-conveying direction.
